(19) United States
(12) Patent Application Publication
(10) Pub. No.: US 2025/0201545 A1
(43) Pub. Date: Jun. 19, 2025

(54) VACUUM SYSTEM FOR A MASS SPECTROMETER

(71) Applicant: Thermo Finnigan LLC, San Jose, CA (US)

(72) Inventors: George B. Guckenberger, Austin, TX (US); Nicholas A. Pedrazas, Austin, TX (US)

(21) Appl. No.: 18/538,840

(22) Filed: Dec. 13, 2023

(51) Int. Cl. H01J 49/24

(52) U.S. Cl. CPC H01J 49/24

(57) ABSTRACT

A vacuum system for a mass spectrometer includes a first vacuum region, a second vacuum region, a vacuum interlock connected to the first vacuum region by a first valve and the second vacuum region by a second valve, a first pump connected to the first and second vacuum regions, a second pump connected to the second vacuum region, a pressure sensor configured to determine the pressure within the second vacuum region, and a controller configured to adjust a position of the second valve in response to the pressure within the second vacuum region. The vacuum interlock is configured to receive a sample. The first pump is configured to decrease a pressure within the first vacuum region and exhaust air to the second vacuum region. The second pump is configured to decrease a pressure within the vacuum interlock. The controller is configured to prevent pressure fluctuations in the second vacuum region.

### FIELD

The present disclosure relates to mass spectrometers. More specifically, the present disclosure relates to a vacuum system and an associated control system to evacuate a vacuum interlock in a mass spectrometer.

### BACKGROUND

Certain markets that use mass spectrometers are focused on processing as large a number of samples through the instrument as possible. In operations involving large sample processing, the mass spectrometer can require a significant amount of time and energy to operate the vacuum system. This can result in both a time intensive and cost intensive processing of samples through the instrument. Accordingly, there is an opportunity to improve the vacuum system to both reduce the time required to complete a vacuum system operational cycle associated with processing of a sample or performing maintenance, and to improve the vacuum system components to decrease energy demand.

### SUMMARY

In one example of an embodiment, a vacuum system for a mass spectrometer includes a first vacuum region, a second vacuum region, a vacuum interlock fluidly connected to the first vacuum region by a first valve and the second vacuum region by a second valve, a first pump fluidly connected to the first and second vacuum regions, a second pump fluidly connected to the second vacuum region, a pressure sensor configured to determine the pressure within the second vacuum region, and a controller configured to incrementally adjust a position of the second valve in response to the pressure within the second vacuum region. The vacuum interlock is configured to receive a sample. The first pump is configured to decrease a pressure within the first vacuum region and exhaust air to the second vacuum region. The second pump is configured to decrease a pressure within the vacuum interlock. The controller is configured to prevent pressure fluctuations in the second vacuum region.

In another example of an embodiment, a method of evacuating a vacuum interlock in a vacuum system of a mass spectrometer, the vacuum system including a first vacuum region fluidly connected to the vacuum interlock by a first valve, a second vacuum region fluidly connected to the vacuum interlock by a second valve, a first pump decreasing a pressure within the first vacuum region, and a second pump decreasing a pressure within the second vacuum region. The method includes a first operational cycle including closing the first and second valves to fluidly isolate the vacuum interlock from the first and second vacuum regions, measuring the pressure within the second vacuum region, opening the second valve incrementally to decrease the pressure in the vacuum interlock, the second valve opened incrementally in response to the pressure within the second vacuum region, closing the second valve in response to the vacuum interlock reaching an operating pressure, and opening the first valve in response to the vacuum interlock reaching the operating pressure to facilitate a transfer of at least one of a sample, an ion source cartridge, or a source plug from the vacuum interlock to the first vacuum region.

Other aspects of the invention will become apparent by consideration of the detailed description and accompanying drawings.

### BRIEF DESCRIPTION OF THE DRAWINGS

FIG. 1 is a schematic view of a mass spectrometer including an embodiment of a vacuum system.

FIG. 2 is a flow diagram providing an example of operational steps of the mass spectrometer of FIG. 1.

FIG. 3 is schematic view of a portion of a mass spectrometer including an alternative embodiment of a vacuum system.

FIG. 4 is a schematic view of the mass spectrometer and associated vacuum system of FIG. 3.

FIG. 5 is a flow diagram providing an example of operational steps of the mass spectrometer of FIG. 3.

FIG. 6 is a flow diagram of an evacuation sequence implemented at step 312 of the operational steps of FIG. 5.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Mass spectrometer systems and methods described herein reduce turnaround time, pump power consumption, and wear and tear on the pumps during exchange of parts (e.g., samples or maintenance parts) from atmosphere to the high vacuum region of the mass spectrometer by carefully controlling the pressure leak (e.g., by controlling a valve's open/closed state) between vacuum regions using a controller. The exchange of parts usually occurs through a vacuum interlock chamber that begins at atmospheric pressure. Careful control of the pressure release from the vacuum interlock chamber using a controller can reduce turnaround time and reduce pump wear and tear by ensuring that all vacuum pumps are working within their optimal pressure differential ranges and pumping speed ranges. Careful control of the pressure release using a controller can also enable the use of smaller vacuum pumps with lower power consumption as these smaller pumps can handily evacuate the reduced gas flow from a controlled release.

When moving parts from outside the vacuum system of the mass spectrometer to inside the system, the vacuum interlock chamber at atmospheric pressure cannot be interfaced directly to the high vacuum region because the sudden rush of high pressure into a high vacuum pump (such as a turbopump) has the potential to damage the high vacuum pump. Thus, the vacuum interlock chamber must be evacuated before it is fluidically interfaced with the high vacuum chamber. In some conventional systems, a roughing pump that backs a high vacuum pump is used to evacuate the vacuum interlock chamber. This arrangement carries potential downsides because the rush of high-pressure air from the vacuum interlock chamber into the roughing pump (and thus to the outlet, or back, of the high vacuum pump) may raise the pressure at the outlet of the high vacuum pump. If the pressure at the outlet of the high vacuum pump becomes too high, the high vacuum pump can become contaminated or overheated or the vacuum level in the high vacuum region can suffer. Mass spectrometer systems and methods described herein overcome these issues by using a controller to carefully control the release of air from the vacuum interlock into the roughing pump to prevent spikes in pressure and ensure that flow rate of air from the vacuum interlock into the roughing pump remains within the capacity of the roughing pump to handle. In various examples described herein, the controller can control the release of air from the vacuum interlock based upon real-time pressure measurements, pre-set values retrieved from a memory, or historical measurements stored in the memory.

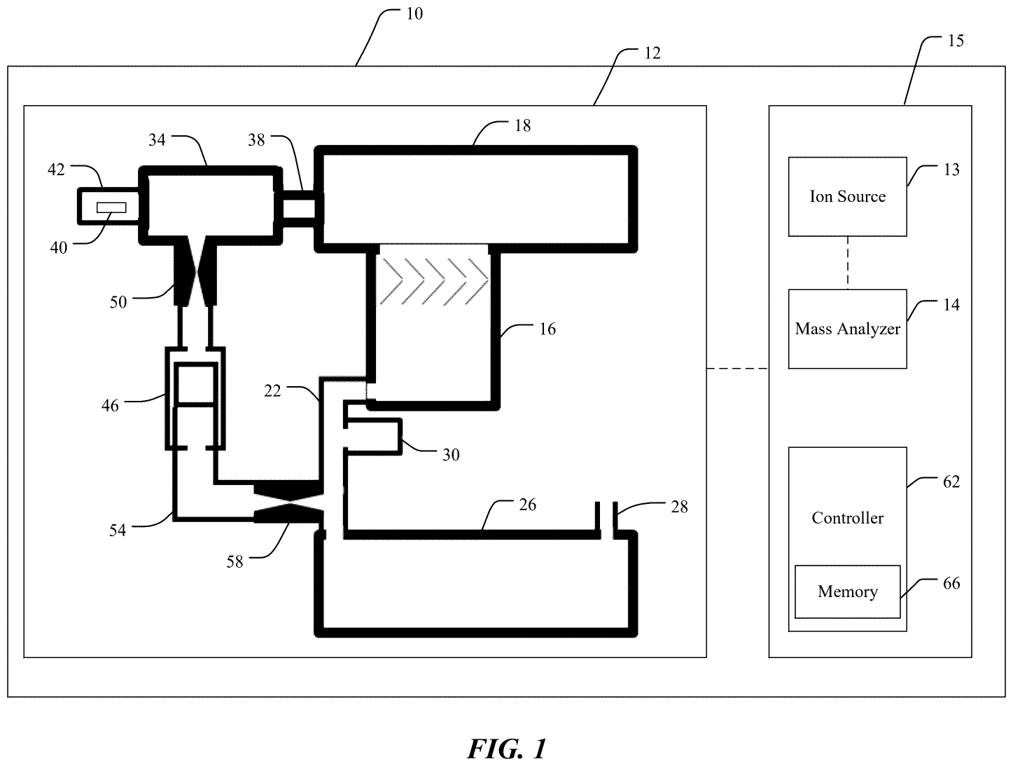

FIG. 1 illustrates an example of an embodiment of a mass spectrometer 10. The mass spectrometer 10 includes a vacuum system 12. The vacuum system 12 is in fluid communication with an ion source 13. The ion source 13 is in fluid communication with a mass analyzer 14. These known components of the mass spectrometer 10 within the vacuum system 12 are represented by the box 15. The vacuum system 12 includes a first pump 16 (also referred to as a high vacuum pump 16) that is fluidly connected to a first vacuum region 18 and a second vacuum region 22. The first vacuum region 18 can also be referred to as a high vacuum region 18, while the second vacuum region 22 can also be referred to as a low vacuum region 22 (or a rough vacuum region 22). The high vacuum pump 16 is configured to generate a first vacuum (e.g., a pressure less than 10⁻⁴ Torr, a pressure less than 3×10⁻⁵ Torr, etc.) within the high vacuum region 18. The high vacuum pump 16 is also configured to exhaust gas into the low vacuum region 22. The high vacuum pump 16 can be any suitable vacuum pump for generating the targeted vacuum in the high vacuum region 18, including but not limited to, a multi-stage turbomolecular pump, a diffusion pump, etc.

A second pump 26 (also referred to as a backing pump 26 or a low vacuum pump 26) is fluidly connected to the low vacuum region 22. The backing pump 26 is configured to evacuate exhaust from the high vacuum pump 16. The backing pump 26 generates a second vacuum (e.g., a pressure less than 5 Torr, a pressure less than 200 milliTorr, etc.) within the low vacuum region 22. The second vacuum is a lesser vacuum than the first vacuum (i.e., the second vacuum has a higher pressure than the first vacuum). The backing pump 26 includes an exhaust valve 28. The backing pump 26 is configured to exhaust air from the low vacuum region 22 into the surrounding atmosphere. A pressure sensor 30 is in communication with the low vacuum region 22. The pressure sensor 30 is configured to detect a pressure within the low vacuum region 22 (also referred to as a backing pressure).

A vacuum interlock 34 is selectively fluidly connected to the high vacuum region 18 by a first valve 38 (also referred to as a high vacuum valve 38). The high vacuum valve 38 can be, for example, a ball valve, a gate valve, or any other suitable valve. The high vacuum valve 38 can be opened to, for example, allow a sample 40 (or a mechanical assembly 40) to enter the high vacuum region 18. The sample 40 can be an analytical sample to be measured. The mechanical assembly 40 can be a cartridge of the ion source 13, a source plug, or any other component of the mass spectrometer 10 that can be exchanged to facilitate maintenance operations. For example, the high vacuum valve 38 can be opened to exchange the cartridge of the ion source 13. The cartridge of the ion source 13 can be exchanged to remove dirty (used) components of the ion source 13 and insert clean (new) components of the ion source 13. The cartridge of the ion source 13 can also be exchanged to change ionization volumes to allow for a different ionization technique (e.g., electron ionization, chemical ionization, etc.). The source plug can be exchanged to, for example, seal a transfer line of a gas chromatograph to allow a column of the gas chromatograph to be exchanged. The sample 40 (or the mechanical assembly 40) can be positioned within a tool 42 (also referred to as a source exchange tool 42 or a sample probe 42). The tool 42 is configured to be coupled to the vacuum interlock 34. The tool 42 is selectively extendable. When the high vacuum valve 38 is opened, the tool 42 can extend to insert the sample 40 into the high vacuum region 18. The vacuum interlock 34 is selectively fluidly connected to the low vacuum region 22 by a second valve 46 (also referred to as an evacuation valve 46). The evacuation valve 46 can be, for example, a solenoid valve, a proportional solenoid valve, a piston spool valve, a poppet valve, or any other suitable valve. A first flow restrictor 50 is positioned between the vacuum interlock 34 and the evacuation valve 46. The first flow restrictor 50 is configured to limit the flow of fluid (e.g., air, water vapor, etc.) between the vacuum interlock 34 and the evacuation valve 46. An expansion volume 54 is positioned between the high vacuum valve 38 and the low vacuum region 22. The expansion volume 54 is configured to provide an increased evacuated volume for incoming fluid to expand into and reduce pressure surge in response to an increase in airflow from the vacuum interlock 34 to the expansion volume 54, which is discussed in further detail below. A second flow restrictor 58 is positioned between the expansion volume 54 and the low vacuum region 22. The second flow restrictor 58 is configured to limit the flow of fluid between the expansion volume 54 and the low vacuum region 22. The first and second flow restrictors 50, 58 can be, for example, fixed gas flow restrictors.

With continued reference to FIG. 1, a controller 62 is configured to communicate with one or more components of the vacuum system 12. For example, the controller 62 is in communication with the first valve 38 and the second valve 46. The controller 62 is configured to detect the position of valve 38 and may open and/or close each of the first and second valves 38, 46. In some examples, the controller 62 may be used to send a signal to a user (i.e., an audio or visual signal such as through a graphical interface) to manually open or close valve 38 in the case that the valve 38 is not electronically controlled. As another example, the controller 62 is in communication with the pressure sensor 30 and is configured to receive pressure measurements in the low vacuum region 22 detected by the pressure sensor 30. In some examples, the controller 62 is configured to read measurements from the pressure sensor 30 at a rate in the range of 5-10 Hertz. The controller 62 can include a memory 66 (also referred to as a database 66). The controller 62 is configured to store measured data in the database 66. In some examples of embodiments, the database 66 can be external from the controller 62 and configured to communicate remotely with the controller 62.

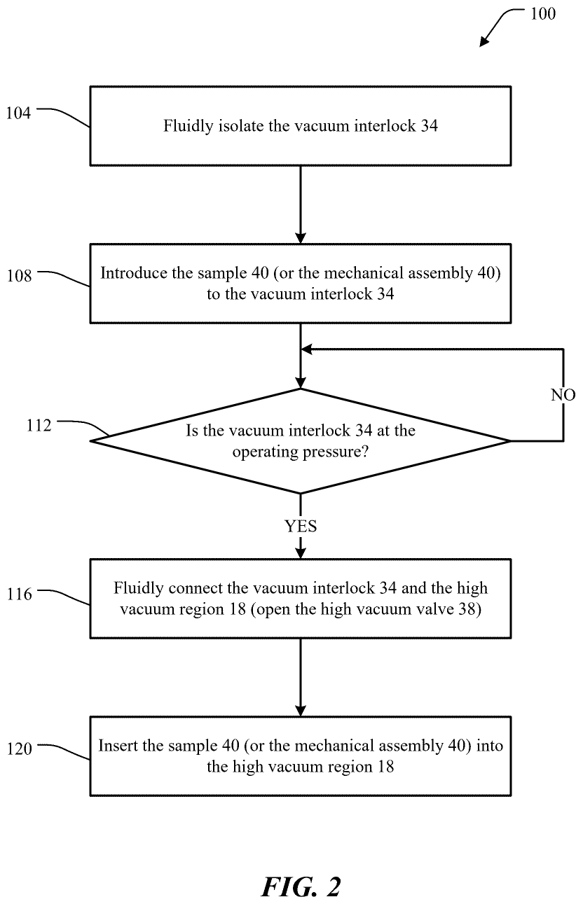

With reference now to FIG. 2, a process of operating the mass spectrometer 100 is illustrated. The process 100 utilizes the mass spectrometer 10 with the vacuum system 12. The process 100 includes a plurality of instructions that are depicted as steps in flow diagram form. The process 100 begins at step 104, where the vacuum interlock 34 is fluidly isolated from the high vacuum region 18, the low vacuum region 22, and the expansion volume 54. The vacuum interlock 34 is isolated by closing the high vacuum valve 38 and the evacuation valve 46. The vacuum interlock 34 is isolated to prevent damage to the high vacuum pump 16. Damage to the high vacuum pump 16 can occur if air in the vacuum interlock 34 rapidly and uncontrollably flows into the low vacuum region 22.

Next, at step 108, a sample 40 is introduced to the vacuum interlock 34. Alternatively, step 108 may include a mechanical assembly 40 introduced to the vacuum interlock 34, which is discussed in further detail below. If step 108 occurs after a sample 40 has been previously tested, and the tool 42 is coupled to the vacuum interlock 34, the tool 42 is removed from the vacuum interlock 34 along with the previously tested sample 40. Removal of the tool 42 fills the vacuum interlock 34 with external air at atmospheric pressure. When filled with air at atmospheric pressure, the vacuum interlock 34 can be referred to as being at a starting pressure. Once the tool 42 is removed, the tool 42 can be cleaned, and any remaining material from the previously tested sample 40 can be removed. The tool 42 can then be reused, with a new sample 40 to be ionized or exchanged being inserted into the tool 42. Alternatively, or additionally, a second tool 42 can carry a new sample 40 to be ionized or exchanged. The tool 42 carrying the new sample 40 is then coupled to the vacuum interlock 34. Coupling the tool 42 to the vacuum interlock 34 seals the vacuum interlock 34 from the external air. The vacuum interlock 34 now includes the new sample 40, which is carried by the tool 42. The vacuum interlock 34 is then sealed at the starting pressure in response to insertion of the tool 42.

Next, at step 112, air is evacuated from the vacuum interlock 34 until the vacuum interlock 34 reaches an operating pressure. The pressure in the vacuum interlock 34 is reduced to facilitate a transfer of the sample 40 from the vacuum interlock 34 to the high vacuum region 18. The air is evacuated from the vacuum interlock 34 from the atmospheric starting pressure to the reduced target pressure (also referred to as an operating pressure). The target pressure is not as low of a pressure as the first vacuum in the high vacuum region 18. However, the target pressure is sufficiently low so as to not create a harmful pressure differential (i.e., a pressure differential that will damage the high vacuum pump 16 or cause a delay in evacuating the low vacuum interlock 34), between the vacuum interlock 34 and the high vacuum region 18. The target pressure can be a predetermined pressure value. The controller 62 can detect the pressure from the pressure sensor 30 to determine whether the vacuum interlock 34 is at the target pressure. For example, once the pressure within the low vacuum region 22 has stabilized, the controller 62 can determine the vacuum interlock 34 is at the target pressure.

The vacuum interlock 34 is evacuated by opening the evacuation valve 46. Opening the evacuation valve 46 can cause a sudden burst of air at atmospheric pressure (also referred to as high pressure air) to exit the vacuum interlock 34 through the evacuation valve 46. The expansion volume 54 is configured to provide an increased evacuated volume for incoming fluid to expand in volume to prevent a pressure differential between the expansion volume 54 and the low vacuum region 22. The pressure of the air in the expansion volume 54 is configured to be efficiently decreased by the backing pump 26. The first restrictor 50 is configured to decrease the flow of the high pressure air into the expansion volume 54. The second restrictor 58 is configured to decrease the flow of the high pressure air from the expansion volume 54 into the low vacuum region 22. The first restrictor 50 and the second restrictor 58 can thus dampen the shock of the sudden pressure change (by introduction of volumes of atmospheric pressure air to the low vacuum region 22) on the low pressure pump 26 and the high pressure pump 16. The backing pump 26 operates to decrease the pressure within the low vacuum region 22.

It should be appreciated that the high vacuum pump 16 can be damaged by a significant pressure differential between the vacuum interlock 34 and the high vacuum region 18. There can be a small pressure differential between the vacuum interlock 34 and the high vacuum region 18, such that once the high vacuum valve 38 is opened, the gas within the vacuum interlock 34 expands into the high vacuum region 18 but does not damage the high vacuum pump 16. The small pressure differential can be caused by, for example, a pressure of 5-10 Torr in the vacuum interlock 34. Once the gas expands into the high vacuum region 18, however, the pressure becomes equal to or less than the pressure in the low vacuum region 22. The significant pressure differential can cause an uncontrolled rapid increase in the pressure within the high vacuum region 18. The increase in backing pressure (also referred to as pressure fluctuations) within the high vacuum region 18 can damage the high vacuum pump 16. The high vacuum pump 16 can also be damaged by a large pressure differential between the expansion volume 54 and the low vacuum region 22. The pressure differential can cause an uncontrolled rapid increase in the backing pressure within the low vacuum region 22. This increase in backing pressure within the low vacuum region 22 can damage the high vacuum pump 16.

The vacuum interlock 34 is evacuated until the pressure in the vacuum interlock 34 reaches the target pressure. The time it takes for the backing pump 26 to decrease the pressure in the vacuum interlock 34 to the target pressure can be referred to as an evacuation time. Stated another way, the evacuation time is the amount of time it takes to decrease the pressure in the vacuum interlock 34 from the starting pressure to the target pressure. It is desired to minimize the evacuation time. In any given time period, the shorter the evacuation time, the greater the number of samples 40 that can be tested by the mass spectrometer 10. Accordingly, it is desired for the backing pump 26 to operate quickly so that a user can test more samples 40. Once controller 62 determines that the vacuum interlock 34 has reached the target pressure, the evacuation valve 46 is closed. At this point, the vacuum interlock 34 is at the target pressure and is fluidly isolated from the rest of the vacuum system 12.

Next, at step 116, once the vacuum interlock 34 reaches the target pressure, the high vacuum valve 38 is opened. The vacuum interlock 34 and the high vacuum valve 38 are now fluidly connected.

Next, at step 120, in response to the high vacuum valve 38 opening, the sample 40 (or the mechanical assembly 40) travels from the vacuum interlock 34 to the high vacuum region 18. The tool 42 can be extended to place the sample 40 within the high vacuum region 18. The sample 40 can then be ionized, accelerated through the ion source 13, and tested.

Following the testing of the sample, the process of operating the mass spectrometer 100 can be repeated with a different sample 40. The process 100 returns to step 104, where the steps are sequentially repeated. It should be appreciated that completing steps 104 to 120 can be referred to as an operational cycle. As such, the process 100 with a first sample 40 can be referred to as a first operational cycle of a plurality of operational cycles. Following the first operational cycle, the process 100 with a second sample 40 can be referred to as a second operational cycle of the plurality of operational cycles. Following the second operational cycle, the process 100 with a third sample 40 can be referred to as a third operational cycle of the plurality of operational cycles. The third operational cycle can be followed by additional operational cycles to define a plurality of operational cycles.

The process 100 describes introducing and measuring the sample 40. It can be appreciated that the process 100 can alternatively be performed to complete a maintenance operation (e.g., exchange the cartridge of the ion source 13, the source plug, etc.). The process 100 will include similar steps that use the mechanical assembly 40 instead of the sample 40. For example, during a process of exchanging the cartridge of the ion source 13, in step 108, the cartridge is introduced into the vacuum interlock 34. In step 120, the cartridge replaces an old cartridge and is then mated with an ion guide.

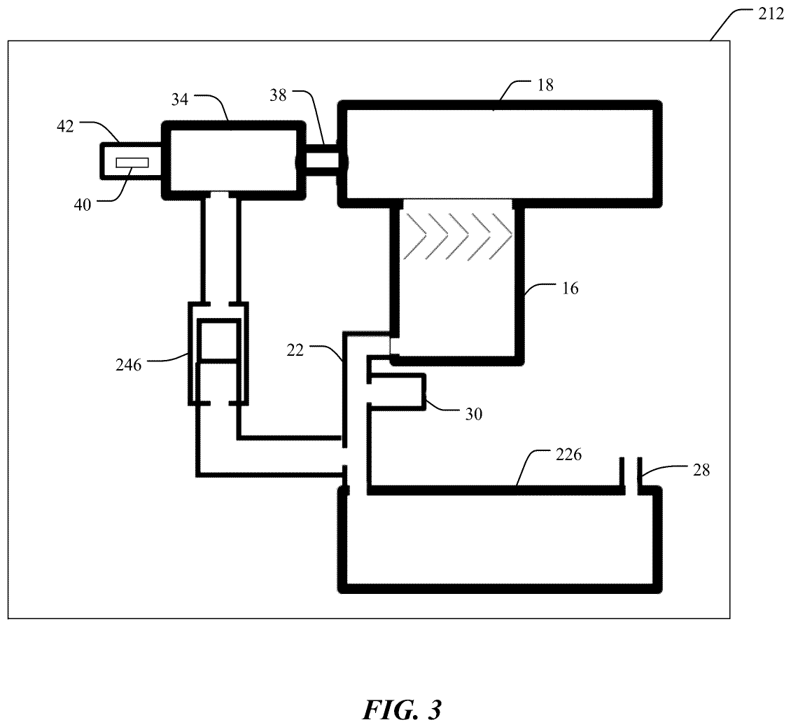

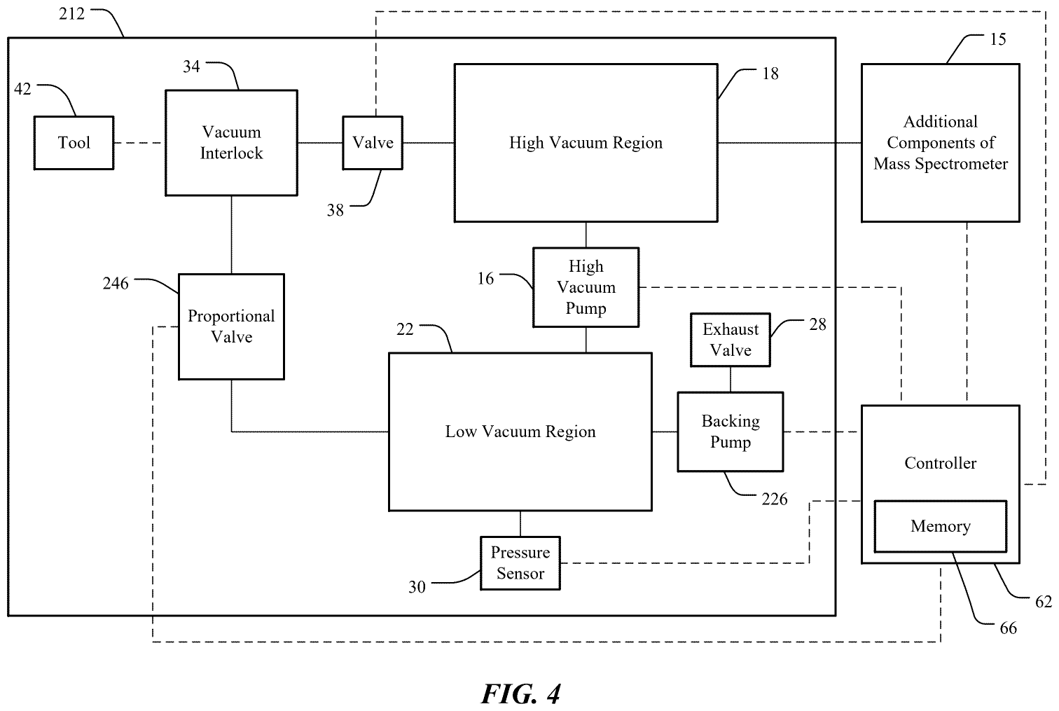

During the process of operating the mass spectrometer 100, the high vacuum pump 16 and the backing pump 26 can account for a significant portion of the operational energy. For example, the power draw of the backing pump 26 can be around 250 Watts, and the power draw of the entire mass spectrometer 10 can be 540-620 Watts. The power draw is required to quickly evacuate the vacuum interlock 34. There is an opportunity to reduce the energy consumption of the mass spectrometer 10 by using a smaller backing pump that consumes less energy. However, utilizing a smaller backing pump instead of the backing pump 26 is not a simple substitution. As such, additional modifications to the mass spectrometer 10 and associated vacuum system are necessary. An example of an embodiment of such a modified system is illustrated in FIGS. 3-4.

FIGS. 3 and 4 illustrate an alternative embodiment of a vacuum system 212 for use with the mass spectrometer 10. The vacuum system 212 includes similar components as the vacuum system 12, with like reference numbers identifying like components. The vacuum system 212 includes a low capacity backing pump 226 (also referred to as a second pump 226). The low capacity backing pump 226 replaces the backing pump 26. The low capacity backing pump 226 can be, for example, a micro-scroll pump, a diaphragm pump, etc. The low capacity backing pump 226 has a significantly smaller power draw than the backing pump 26. For example, the low capacity backing pump 226 can have a power draw of around 30-50 Watts. Accordingly, the low capacity backing pump 226 can use approximately 12-20% the power of the backing pump 26. The low capacity backing pump 226 can also operate at a reduced audible sound relative to the backing pump 26. However, the low capacity backing pump 226 also has a slower pumping speed than the backing pump 26. Accordingly, if the low capacity backing pump 226 is simply swapped for the backing pump 26 in the vacuum system 12, the vacuum system 12 may not operate at a sufficient speed to timely introduce samples for ionization and analysis (e.g., under 30 seconds, under 15 seconds, etc.). Rather, it could take a very long time (e.g., five minutes, 15 minutes, etc.) to evacuate the vacuum interlock 34 if the vacuum system 12 used the fixed gas first and second flow restrictors 50, 58 and the expansion volume 54. To use the low capacity backing pump 226 and operate at a speed sufficient to timely cycle samples, the vacuum system 212 includes a proportional valve 246 (also referred to as a second valve 246 or an evacuation valve 246). The proportional valve 246 can be, for example, a solenoid valve. The proportional valve 246 replaces the evacuation valve 46. The proportional valve 246 is configured to be incrementally opened by the controller 62 to evacuate the vacuum interlock 34 to the target pressure. For example, the controller 62 can adjust a conductance of the proportional valve 246 by adjusting a position of the proportional valve 246. The controller 62 is configured to minimize the evacuation time by using data stored in the database 66 to optimize opening the proportional valve 246, which is discussed in further detail below. In some examples, the vacuum system 212 does not include the restrictors or expansion volume 54 as in vacuum system 12. By removing the expansion volume (i.e., minimizing the volume between the low capacity backing pump 226 and the proportional valve 246) and restrictors, the total volume being pumped by the low capacity backing pump 226 is reduced and the total time to evacuate the vacuum interlock 34 can therefore be reduced while, at the same time, detrimental pressure surges or spikes can be avoided.

In other examples, the second valve 246 can be an on/off valve that the controller 62 operates on a fixed or variable duty cycle. For example, the controller 62 can cycle the valve 246 between “on” and “off” states in short bursts. In some examples, the effect of cycling the valve 246 is that the valve 246 does not fully open or fully close during the cycle period, and the resulting gas flow through the valve 246 is thus controllable in a similar fashion as described above using proportional valves. Duty cycle operation of the valve 246 can have the advantage that a wider variety of nominally “full on/full off” (i.e., non-proportional) valves can be used in conjunction with the system.

With specific reference to FIG. 4, the high vacuum pump 14, high vacuum valve 38, low capacity backing pump 226, proportional valve 246, and pressure sensor 30 are in communication with the controller 62. The communication is illustrated with broken lines. The communication can be wired, wireless, or any suitable system for communication (e.g., radio, cellular, BLUETOOTH®, etc.). The controller 62 is configured to receive operational data from at least one of the high vacuum pump 14, high vacuum valve 38, low capacity backing pump 226, proportional valve 246, and/or pressure sensor 30. The controller 62 can then save the received operational data in the database 66.

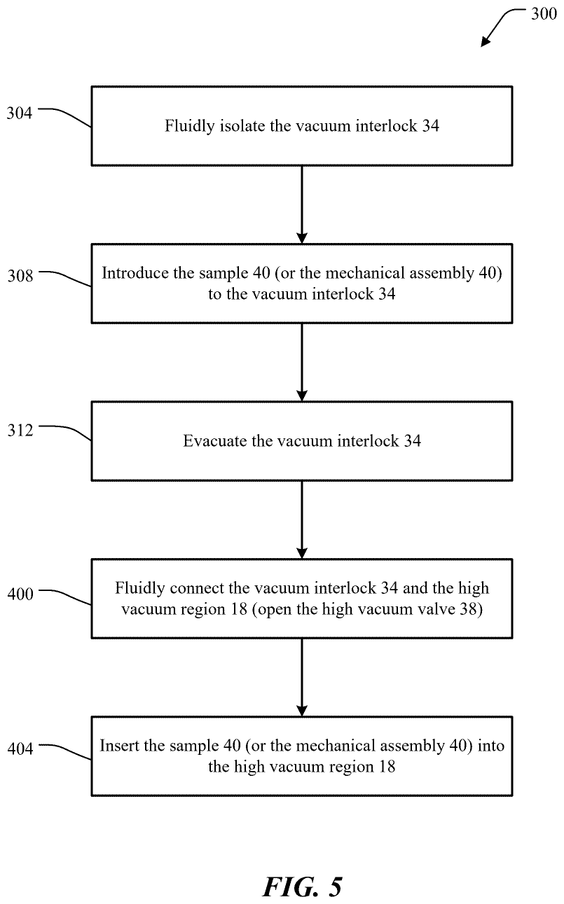

With reference to FIG. 5, an example of a process of operating the mass spectrometer 300 is illustrated. The process 300 utilizes the mass spectrometer 10 with the vacuum system 212. The process 300 includes a plurality of instructions or steps that are depicted in flow diagram form. The process 300 begins at step 304, where the vacuum interlock 34 is fluidly isolated from the high vacuum region 18 and the low vacuum region 22. The vacuum interlock 34 is isolated by closing the high vacuum valve 38 and the proportional valve 246.

Next, at step 308, if the tool 42 is coupled to the vacuum interlock 34, the tool 42 is removed from the vacuum interlock 34. Removal of the tool 42 fills the vacuum interlock 34 with external air at atmospheric pressure. Step 308 is the same as step 108. As such, step 308 can include the same steps and features as described in association with step 108 shown in FIG. 2.

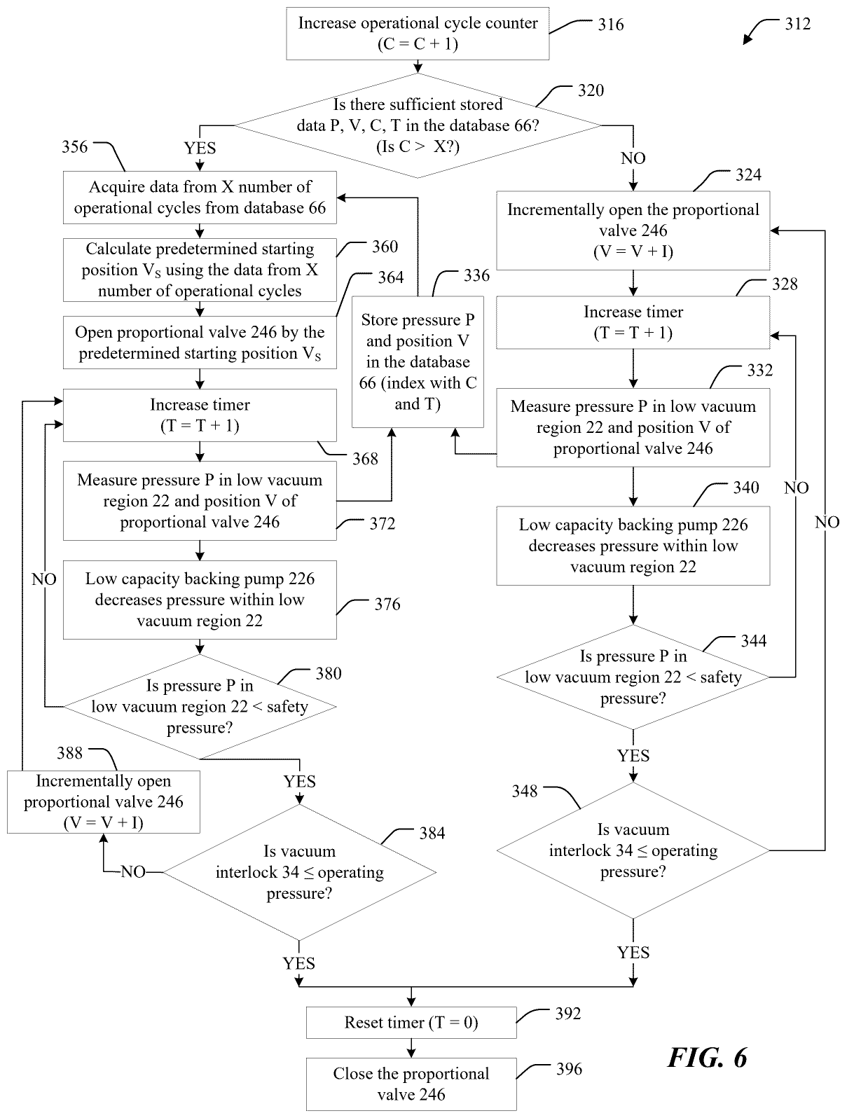

Next, at step 312, air is evacuated from the vacuum interlock 34 until the vacuum interlock 34 reaches the operating pressure. With reference now to FIG. 6, step 312 is illustrated in greater detail.

At step 316, the controller 62 increases the operational cycle counter C. The operational cycle counter C is a number associated with a corresponding operational cycle of the plurality of operational cycles. In the illustrated embodiment, the operational cycle counter C is increased by one for each operational cycle, or C=C+1. Accordingly, as an example, prior to a first operational cycle, the operational cycle counter C increases from a value of 0 to a value of 1 (C=1, as 0+1=1). As another example, prior to a second operational cycle, C=1, the operational cycle counter C increases from a value of 1 to a value of 2 (C=2, as 1+1=2). In other examples of embodiments, any suitable counter can be implemented to track a number of operational cycles.

Next, at step 320, the controller 62 uses the operational cycle counter C to determine if there is enough detected pressure P, position V, operational cycle counter C, and time counter T values stored in the database 66 to properly calculate a starting valve position V_{S} of the proportional valve 246 during the operational cycle. The pressure sensor 30 is configured to detect the pressure P within the low vacuum region 22. The controller 62 is configured to detect the position V of the proportional valve 246. The controller 62 is also configured to determine an operational cycle counter C, and the time counter T. The controller 62 is also configured to store the detected pressure P and position V values and the determined operational cycle counter C and time counter T values in the database 66. The controller 62 can then use the stored pressure P, position V, operational cycle counter C, and time counter T values to calculate the starting valve position V_{S}. Stated another way, the controller 62 determines if the proportional valve 246 should be opened to a calculated starting valve position V_{S} or if the proportional valve 246 should be incrementally opened. In the illustrated embodiment, the controller 62 determines if the operational cycle counter C is greater than a predetermined number of cycles X. The predetermined number of cycles X is representative of a number of cycles necessary to store sufficient data suitable to calculate a starting valve position V_{S}. As a nonlimiting example, the predetermined number of cycles X can be equal to ten (X=10). In this example of an embodiment, the controller 62 determines whether there have been more than ten cycles, such that more than ten cycles of detected pressure P, proportional valve position V, and time counter T values have been stored in the database 66. In other embodiments, the predetermined value X can be any suitable number (e.g., one, five, fifteen, etc.). If the controller 62 determines no, the mass spectrometer 10 has not operated a sufficient number of operational cycles to store sufficient pressure P, position V, and time counter T values in the database 66, the process proceeds to step 324.

Entering step 324, the controller 62 incrementally opens the proportional valve 246 by an increment I. The increment I is equal to an adjustment amount of the position V of the proportional valve 246. Adjusting the position V of the proportional valve 246 incrementally by the increment I is configured to keep the pressure in the low vacuum region 22 at or below a safety pressure. The low vacuum region 22 is fluidly connected to the high vacuum pump 16. Air above the safety pressure entering the high vacuum pump 16 can damage the high vacuum pump. In some embodiments, the controller 62 is configured to keep the pressure in the low vacuum region 22 below the safety pressure multiplied by a safety factor. The safety factor can, for example, ensure that the pressure in the low vacuum region 22 does not get close to the safety pressure. The safety pressure can be multiplied by the safety factor, and the product can be referred to as an adjusted safety pressure. When the position V of the proportional valve 246 is expressed as a percentage, the increment I can equal, for example, 1.0% when the proportional valve 246 is opened from zero percent (0.0%) to one percent (1.0%) opened. In other embodiments, the increments I can be any suitable amount to safely facilitate opening of the proportional valve 246 (e.g., 0.25%, 0.50%, 0.75%, 1.25%, 1.50%, etc.).

Next, at step 328, the controller 62 increases the time counter T. The time counter T can count a unit of time throughout each operational cycle. In one non-limiting embodiment, the time counter T can be associated with each second and/or portion of a second elapsed during an associated operational cycle. For example, T can equal five (5) after five (5) seconds, T can equal ten (10) after ten (10) seconds, etc. The time counter T can be reset for each operational cycle. Increasing the time counter T indicates that the unit of time has increased. In the illustrated embodiment, the time counter T is increased by one (1) unit, or T=T+1. In other embodiments, any counter can be implemented that is suitable to track a unit of time. In other examples of embodiments, any suitable unit of time can be utilized (e.g., seconds, half seconds, milliseconds, etc.).

Next, at step 332, the pressure P in the low vacuum region 22 is measured. The pressure sensor 30 measures the pressure P. The position V of the proportional valve 246 is also detected. The position V of the proportional valve 246 can be received from the proportional valve 246. In one non-limiting embodiment, the position V of the proportional valve 246 can be expressed as a percentage. For example, the position V can be 0% when the proportional valve 246 is completely closed, the position can be 50% when the proportional valve 246 is half opened, and the position V can be 100% when the proportional valve 246 is completely open.

Next, at step 336, the controller 62 stores the detected pressure P, detected proportional valve position V, operational cycle counter C, and time counter T values in the database 66. The measured pressure P and the measured position V can be indexed with the time counter T and the operational cycle counter C. Stated another way, for each value of the operational cycle counter C, there will be a plurality of time counter values T. The combination of specific operational cycle and time counter values C, T will correspond with a specific point in time during an operational cycle. As such, the pressure P and valve position V are stored in the database 66 at the specific time T. In one non-limiting embodiment, the operational cycle counter C can serve as an X-axis variable, and the time counter T can serve as the Y-axis variable. In this non-limiting embodiment, the unit of pressure P is Torr, the unit for the position V is the percentage open of the proportional valve 246, and the format is listed as (P, V). For a first example data point, at C=1, T=1, the pressure P is measured at 5 Torr following opening the proportional valve 246 from 0% to 1.0% (i.e., an increment I of 1.0%). Accordingly, the first example data point is (5, 1) located at C=1, T=1.

At step 340, as the high pressure air enters the low vacuum region 22, the low capacity backing pump 226 operates to initiate or reestablish the second vacuum level by lowering the pressure in the low vacuum region 22. The low capacity backing pump 226 exhausts the air arriving through the valve 246 to the outside of the mass spectrometer 10 through the exhaust valve 28.

Next, at step 344, the controller 62 determines if the pressure P within the low vacuum region 22 is less than the safety pressure (or the adjusted safety pressure). If no, the pressure P within the low vacuum region 22 has not been lowered enough by the low capacity backing pump 226 and the process then returns to step 328 to increase the time counter T. Steps 328 to 344 then repeat until the detected pressure P within the low vacuum region 22 is less than the safety pressure (or the adjusted safety pressure). As a non-limiting example, in an embodiment where the safety pressure is ten (10) Torr, during the operational cycle, the controller 62 opens the proportional valve 246 incrementally by the increment I. The pressure in the low vacuum region 22 increases (the vacuum decreases). If the detected vacuum pressure is above the safety pressure, the low capacity backing pump 226 operates to reduce the pressure (or increase the vacuum) to a pressure at or below ten (10) Torr before proceeding into step 348. In some embodiments, the controller 62 can decrease the valve position V. For example, if the pressure P in the low vacuum region 22 has risen too high, the controller 62 may decrease the valve position V to return the pressure P more quickly below the safety pressure. Decreasing the valve position V can be referred to as adjusting the proportional valve 246 by a negative increment I (i.e., an increment I with a negative value). If yes, the pressure P in the low vacuum region 22 is less than the safety pressure, the process proceeds to step 348.

At step 348, the controller 62 determines if the vacuum interlock 34 is at or below the operating pressure. Said another way, the controller 62 determines if the vacuum interlock 34 is completely evacuated. In one example of an embodiment, the controller 62 uses the position V at 100% (i.e., the proportional valve 246 is completely opened) as a proxy for if the vacuum interlock 34 is at the operating pressure. In other embodiments, the controller 62 can use the position V at a different percentage (e.g., 75%, 80%, etc.) as a proxy for if the vacuum interlock 34 is at the operating pressure. In yet other examples of embodiments, a second pressure sensor (not shown) can be coupled to the vacuum interlock 34. In these embodiments, the second pressure sensor is connected to the controller 62 and can send the controller 62 pressure readings from within the vacuum interlock 34. The controller 62 can then use the pressure readings from the second pressure sensor to determine if the vacuum interlock 34 has reached the target pressure. If no, the controller 62 returns to step 324 to incrementally open the proportional valve 246 further. Steps 324 to 348 then repeat until the pressure within the vacuum interlock 34 is less than or equal to the operating pressure.

Returning to step 320, if the controller 62 determines yes, there have been sufficient operational cycles to calculate the starting position V_{S}, the process proceeds to step 356. At step 356, the controller 62 acquires pressure P, position V, operational cycle counter C, and time counter T values stored in the database 66. In the illustrated embodiment, the controller 62 acquires pressure P, position V, operational cycle counter C, and time counter T values stored in the database 66 from X number of operational cycles. X can be equal to any integer (e.g., 10, 20, etc.).

At step 360, the controller 62 uses the acquired pressure P, position V, operational cycle counter C, and time counter T values to calculate the starting position V_{S} of the proportional valve 246. The controller 62 calculates the starting position V_{S} with the goal of reducing the evacuation time (associated with the time counter T) while keeping the pressure in the low vacuum region 22 below the safety pressure (or the adjusted safety pressure). The controller 62 can implement any suitable set of calculations to determine the proportional valve starting position V_{S}. In one example of an embodiment, controller 62 can analyze one or more of the stored pressure P, position V, operational cycle counter C, and time counter T values of the cycles C. As a nonlimiting example, the controller 62 can determine the valve position V where detected pressure P is less than the safety pressure. The valve position V can be implemented as the starting position V_{S}. In addition, or alternatively, the controller 62 can calculate a moving average for the cycles C of the valve position V where detected pressure P is less than the safety pressure, and implementing that moving average valve position V as the starting position V_{S}.

At step 364, the controller 62 adjusts the position V of the proportional valve 246 to the calculated starting position V_{S}.

At step 368, the controller 62 increases the time counter T. Increasing the time counter T indicates that the unit of time has increased. Step 368 is the same as step 328. As such, step 368 can include any features as described in reference to step 328.

At step 372, the pressure sensor 30 measures the pressure in the low vacuum region 22. The position V of the proportional valve 246 can also be measured. Step 372 is the same as step 332. As such, step 372 can include any features as described in reference to step 332. After step 372, steps 336 and 376 are initiated. At step 336, the pressure P, position V, operational cycle counter C, and time counter T values are stored in the database 66, as described in further detail above.

At step 376, as the high pressure air enters the low vacuum region 22, the low capacity backing pump 226 operates to lower the pressure in the low vacuum region 22. Step 376 is the same as step 340. As such, step 376 can include any features as described in reference to step 340.

At step 380, the controller 62 determines if the pressure P within the low vacuum region 22 is less than the safety pressure (or the adjusted safety pressure). Step 380 is the same as step 344. As such, step 380 can include any features as described in reference to step 344. If no, the pressure P within the low vacuum region 22 has not been lowered enough by the low capacity backing pump 226, so the controller 62 returns to step 368 to increase the time counter T. Steps 368 to 380 then repeat until the detected pressure P within the low vacuum region 22 is less than the safety pressure (or the adjusted safety pressure). If yes, the pressure P in the low vacuum region 22 is less than the safety pressure, and the controller 62 proceeds to step 384.

At step 384, the controller 62 determines if the vacuum interlock 34 is at or below the operating pressure. Step 384 is the same as step 348. As such, step 384 can include any features as described in reference to step 348. If no, the controller 62 proceeds to step 388.

At step 388, the controller 62 incrementally opens the proportional valve 246 by the increment I. Step 388 is the same as step 324. As such, step 388 can include and features as described in reference to step 324. After step 388, the controller 62 returns to step 368 to increase the time counter T.

Returning to step 348, if yes, the controller 62 proceeds to step 392. Similarly, at step 384, if yes, the controller proceeds to step 392. At step 392, the controller 62 resets the time counter T to zero (0). Once the controller 62 resets the time counter T to zero (0), the previous time counter T value stored in the database 66 will serve as a measurement of the evacuation time of the corresponding operational cycle C. For example, the last time counter T value stored in the database can be thirty (30) before the time counter T is reset to zero (0). In this example, the evacuation time is thirty (30) time units. The controller 62 can subsequently attempt to decrease the evacuation time during future operational cycles.

At step 396, the vacuum interlock 34 is at or below the target pressure, and the controller 62 closes the proportional valve 246. Stated another way, the controller 62 adjusts the valve position V to zero (0). Once the proportional valve 246 is closed, the vacuum interlock 34 is fluidly isolated from the rest of the vacuum system 12. After step 396, step 312 concludes. With returned reference to FIG. 5, after step 312, the controller proceeds to step 400.

Next, at step 400, once the vacuum interlock 34 reaches the operating pressure, the high vacuum valve 38 is opened. In some embodiments in which the high vacuum valve 38 is manually operated, the user can be instructed by, for example, the graphical user interface to open the vacuum valve 38. The vacuum interlock 34 and the high vacuum valve 38 are now fluidly connected. Step 400 is the same as step 116. As such, step 400 can include any features as described in reference to step 116.

Next, at step 404, in response to the high vacuum valve 38 opening, the sample 40 (or the mechanical assembly 40) travels from the vacuum interlock 34 to the high vacuum region 18. In some embodiments, the tool 42 can be extended to place the sample 40 (or the mechanical assembly 40) within the high vacuum region 18. The sample 40 can then be ionized and tested. Step 404 is the same as step 120. As such, step 404 can include any features as described in reference to step 120.

The process 300 describes introducing and measuring the sample 40. It can be appreciated that the process 300 can alternatively be performed to complete a maintenance operation (e.g., exchange the cartridge of the ion source 13, the source plug, etc.). The process 300 will include similar steps that use the mechanical assembly 40 instead of the sample 40. For example, during a process of exchanging the cartridge of the ion source 13, in step 308, the cartridge is introduced into the vacuum interlock 34. In step 404, the cartridge replaces an old cartridge and is then mated with the ion guide.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A vacuum system for a mass spectrometer, the vacuum system comprising:
a first vacuum region;
a second vacuum region;
a vacuum interlock fluidly connected to the first vacuum region by a first valve, the vacuum interlock fluidly connected to the second vacuum region by a second valve, the vacuum interlock configured to receive a sample;
a first pump fluidly connected to the first and second vacuum regions, the first pump configured to decrease a pressure within the first vacuum region and exhaust air to the second vacuum region;
a second pump fluidly connected to the second vacuum region, the second pump configured to decrease a pressure within the vacuum interlock;
a pressure sensor configured to determine the pressure within the second vacuum region; and
a controller configured to incrementally adjust a position of the second valve in response to the pressure within the second vacuum region, the controller configured to prevent pressure fluctuations in the second vacuum region.

2. The vacuum system of claim 1, wherein the second vacuum region has a higher pressure than the first vacuum region.

3. The vacuum system of claim 1, wherein in a first operational cycle, the controller adjusts the position of the second valve to a first predetermined initial position, the position of the second valve over time is stored in a memory, and a pressure of the second vacuum region over time is stored in the memory.

4. The vacuum system of claim 3, wherein in a second operational cycle after the first operational cycle, the controller adjusts the position of the second valve to a second calculated initial position, a position of the second valve over time is stored in the memory, and a pressure of the second vacuum region over time is stored in the memory.

5. The vacuum system of claim 4, wherein in response to the stored position of the second valve over time and the pressure of the second vacuum region over time from the first operational cycle, the controller adjusts the position of the second valve to the second calculated initial position in the second operational cycle.

6. The vacuum system of claim 5, wherein the second calculated initial position is different than the first predetermined initial position.

7. The vacuum system of claim 5, wherein in a third operational cycle after the first and second operational cycles, in response to the stored position of the second valve over time and the pressure of the second vacuum region over time from the first and second operational cycles, the controller adjusts the second valve to a third calculated initial position.

8. The vacuum system of claim 7, wherein the third calculated initial position is different than the first predetermined initial position and the second calculated initial position.

9. The vacuum system of claim 1, wherein
in response to receiving the sample, the vacuum interlock is at a starting pressure,
in response to the second valve being completely opened, the vacuum interlock is at an operating pressure, and
the starting pressure is greater than the operating pressure.

10. The vacuum system of claim 9, wherein an evacuation time is defined between the vacuum interlock at the starting pressure and the operating pressure, and wherein the controller is configured to minimize the evacuation time.

11. The vacuum system of claim 10, wherein the first valve is opened in response to the vacuum interlock reaching the operating pressure, and wherein the operating pressure is a pressure at which the first pump safely operates.

12. The vacuum system of claim 1, wherein in response to opening the second valve, pressure within the second vacuum region increases.

13. The vacuum system of claim 12, wherein the pressure fluctuations in the second vacuum region cause damage to the first pump.

14. The vacuum system of claim 1, wherein the second pump requires less than 50 Watts of power.

15. The vacuum system of claim 1, wherein the controller reads the pressure of the second vacuum region at a rate of at least 5 Hertz.

16. A method of evacuating a vacuum interlock in a vacuum system of a mass spectrometer, the vacuum system including a first vacuum region fluidly connected to the vacuum interlock by a first valve, a second vacuum region fluidly connected to the vacuum interlock by a second valve, a first pump decreasing a pressure within the first vacuum region, and a second pump decreasing a pressure within the second vacuum region, the method comprising a first operational cycle including:
closing the first and second valves to fluidly isolate the vacuum interlock from the first and second vacuum regions;
measuring the pressure within the second vacuum region;
opening the second valve incrementally to decrease the pressure in the vacuum interlock, the second valve opened incrementally in response to the pressure within the second vacuum region;
closing the second valve in response to the vacuum interlock reaching an operating pressure; and
opening the first valve in response to the vacuum interlock reaching the operating pressure to facilitate a transfer of at least one of a sample, an ion source cartridge, or a source plug from the vacuum interlock to the first vacuum region.

17. The method of claim 16, further comprising storing a position of the second valve over time and storing the pressure within the second vacuum region over time.

18. The method of claim 17, further comprising a second operational cycle including
calculating an initial position in response to the stored position of the second valve over time and the stored pressure within the second vacuum region over time in the first operational cycle, and
opening the second valve to the initial position to decrease the pressure in the vacuum interlock.

19. The method of claim 18, wherein the second operational cycle includes opening the second valve incrementally to decrease the pressure in the vacuum interlock.

20. The method of claim 19, wherein
the first operational cycle defines a first evacuation time,
the second operational cycle defines a second evacuation time, and
the second evacuation time is less than the first evacuation time.
